(19) United States
(12) Patent Application Publication
(10) Pub. No.: US 2025/0200535 A1
(43) Pub. Date: Jun. 19, 2025

(54) CRYPTOCURRENCY TRANSACTION BACKUP SYSTEM

(71) Applicant: PAYPAL, INC., San Jose, CA (US)

(72) Inventors: Norihiro Edwin Aoki, Woodside, CA (US); MNehak Jethmalani, Jersey City, NJ (US); Ganesh Thangarasu, Chennai (IN); Selva Priya Baskran, Chennai (IN); Paul Unterberg, San Jose, CA (US); Piyush Kaushal, San Jose, CA (US)

(21) Appl. No.: 18/654,830

(22) Filed: May 3, 2024

(30) Foreign Application Priority Data
Dec. 18, 2023 (IN) 20231086441

(51) Int. Cl. G06Q 20/06

(52) U.S. Cl. CPC G06Q 20/065; G06Q 2220/00

(57) ABSTRACT

The disclosed computer-implemented method includes detecting an unavailability of a primary cryptocurrency exchange system and queuing received cryptocurrency transaction requests. The method also includes connecting to a backup cryptocurrency exchange system and completing the queued cryptocurrency transaction requests with a backup asset pool using the backup cryptocurrency exchange system. The method further includes detecting an availability of the primary cryptocurrency exchange system and reconnecting to the primary cryptocurrency exchange system. Various other methods, systems, and computer-readable media are also disclosed.

### CROSS REFERENCE TO RELATED APPLICATION

This application claims the benefit of Indian Provisional Patent Application No. 202311086441, filed 18 Dec. 2023, the disclosure of which is incorporated, in its entirety, by this reference.

### BACKGROUND

Transaction systems, such as cryptocurrency transaction systems, often require various network-connected systems. For example, a transaction platform may allow users to perform transactions (e.g., buying, selling, trading, processing, etc.) by transparently connecting to other systems, such as a pricing service and/or a trading service, to complete actual transactions. In other words, the transaction platform may rely on partner services/systems for completing transactions.

Outages of the partner systems may prevent users from obtaining price information (e.g., current cryptocurrency price information), buying or selling cryptocurrencies, transferring or trading cryptocurrencies, and other related functions. These outages may be planned (e.g., for performing updates or other maintenance functions) or unplanned (e.g., errors with systems and/or networks). Outages may result in users not being able to perform transactions and in some cases, prevent users from viewing their related accounts. Thus, there is a need for a cryptocurrency transaction backup system.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an exemplary transaction flow for a cryptocurrency transaction backup system.

FIG. 2 is a flow diagram for responding to an unavailable cryptocurrency transaction system with a cryptocurrency transaction backup system.

FIG. 3A-B are block diagrams of an exemplary cryptocurrency transaction backup system.

FIG. 4 is a block diagram of an exemplary asset pool management system.

FIG. 5 is a flow diagram of an exemplary method for responding to a disconnected cryptocurrency transaction system with a cryptocurrency transaction backup system.

FIG. 6 is a block diagram of an exemplary system for a cryptocurrency transaction backup system.

FIG. 7 is a block diagram of an exemplary network for a cryptocurrency transaction backup system.

FIG. 8 is a flow diagram of an exemplary method for managing transactions for a disconnected transaction system with a transaction backup system.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to a cryptocurrency transaction backup system. As will be explained in greater detail below, implementations of the present disclosure detect when a primary cryptocurrency exchange system is unavailable, and connect to a backup cryptocurrency exchange system. Cryptocurrency transaction requests may be queued until the backup cryptocurrency exchange system completes the transaction requests using a backup asset pool. When the primary cryptocurrency exchange system is available, the systems and methods described herein may reconnect to the primary cryptocurrency exchange system. By using the backup cryptocurrency exchange system, the systems and methods provided herein may advantageously improve the functioning of a computer itself by using the backup cryptocurrency exchange system to continue operation when the primary cryptocurrency exchange system exhibits outages. In addition, the systems and methods described herein may improve the technical field of cryptocurrency and/or other transaction systems by providing a technical solution to partial system and/or network failures by connecting to and using appropriate backup systems.

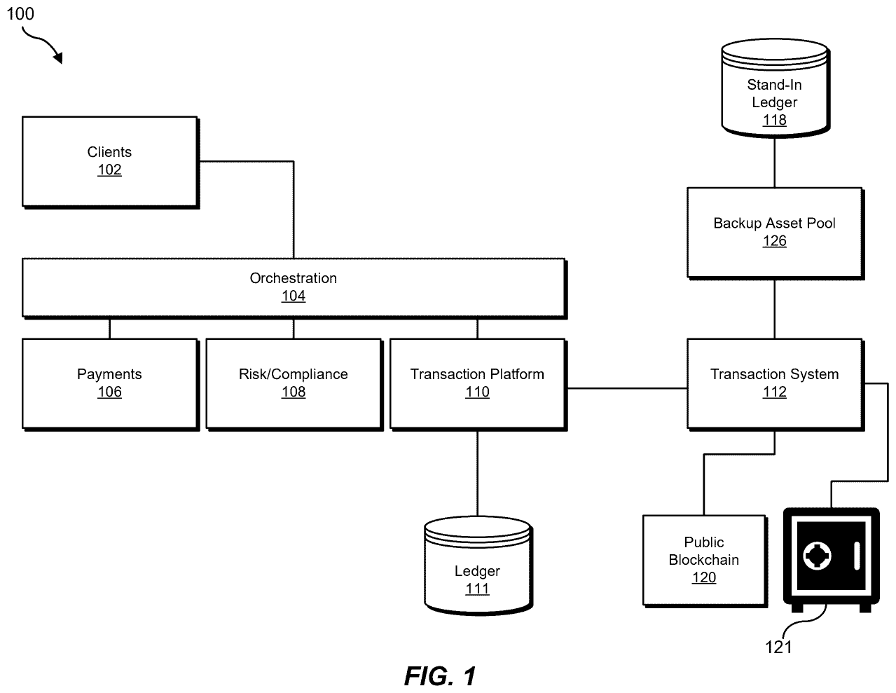

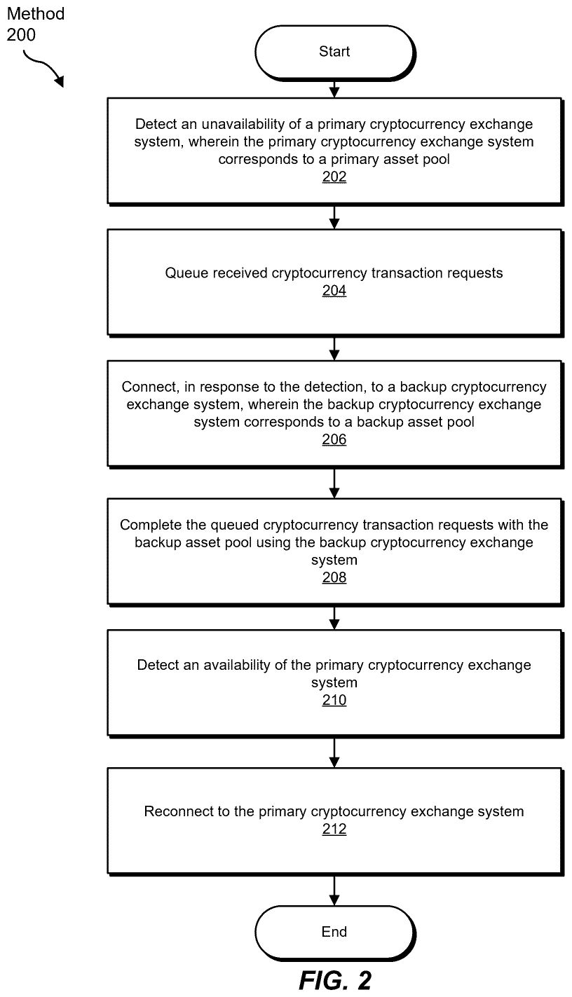

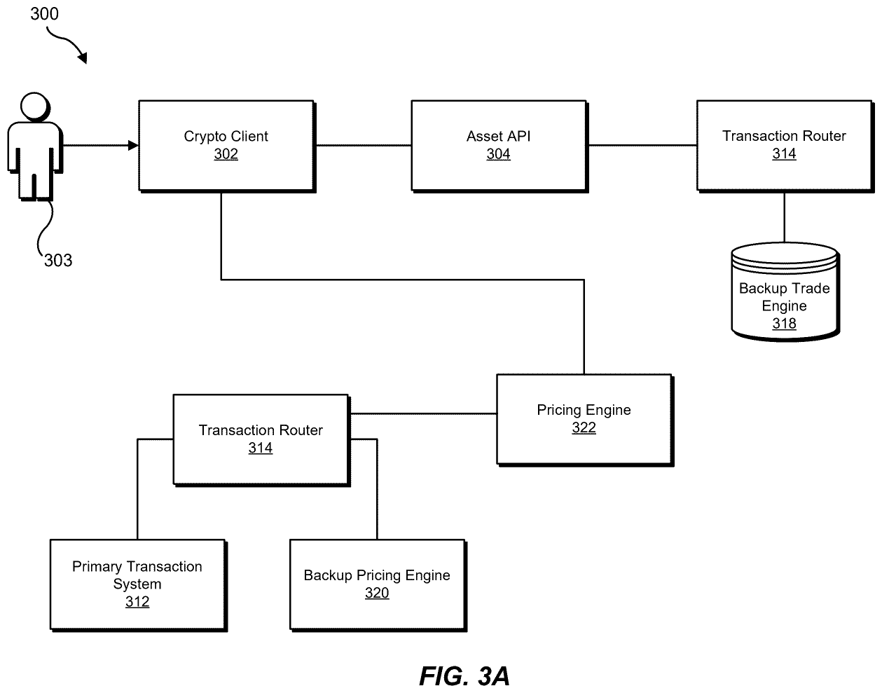

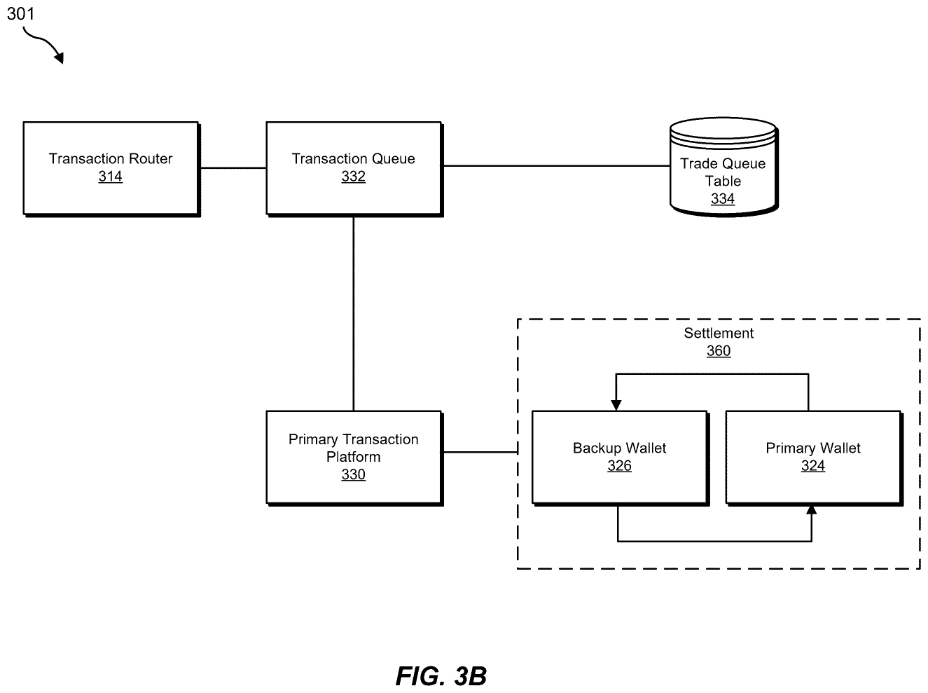

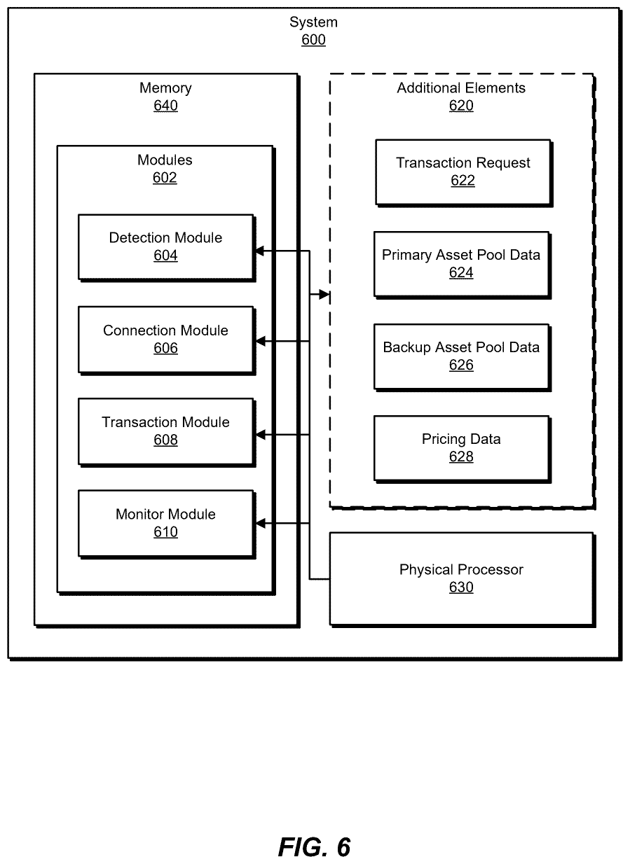

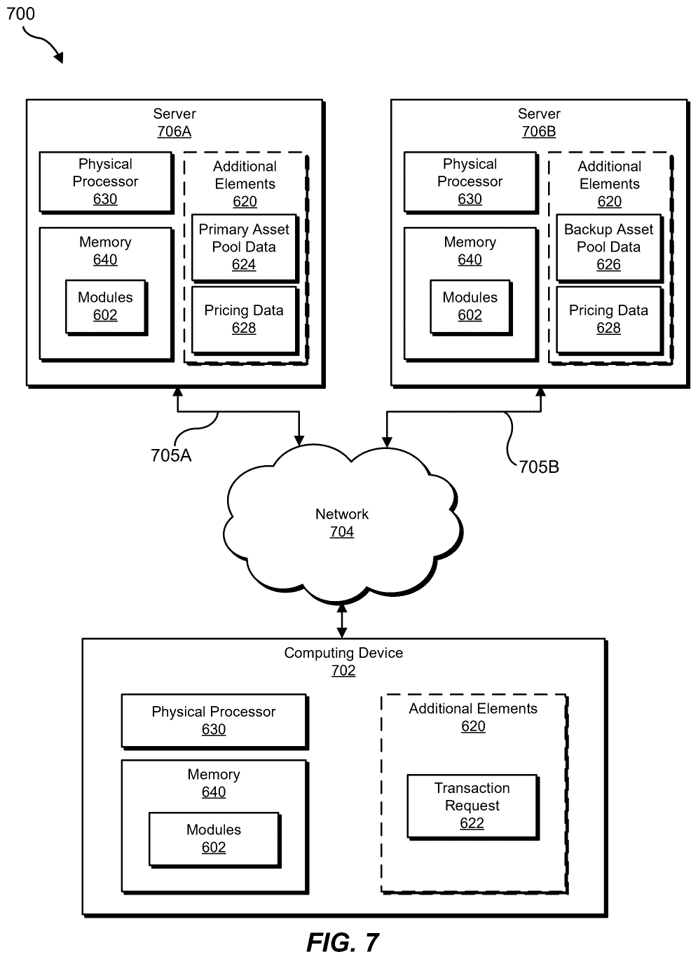

The following will provide, with reference to FIGS. 1-8, detailed descriptions of a cryptocurrency transaction backup system. Detailed descriptions of example cryptocurrency transaction backup systems will be provided in connection with FIGS. 1, 3A-B, 4, 6, 7, and 8. Detailed descriptions of corresponding computer-implemented methods will also be provided in connection with FIGS. 2, 5, and 8. In addition, detailed descriptions of an example computing system and network architecture capable of implementing one or more of the implementations described herein will be provided in connection with FIGS. 6 and 7 respectively.

FIG. 1 illustrates a system 100 for an example stand-in (e.g., backup) transaction flow for a cryptocurrency transaction. A user may use clients 102 (corresponding to user-facing interfaces such as applications, websites, etc.) for using a transaction platform 110 (e.g., corresponding to system for viewing/managing cryptocurrency assets and related pricing information as well as initiate transactions, such as buying or selling) that interfaces with a cryptocurrency transaction system such as transaction system 112 (corresponding to a system for conducting cryptocurrency transaction as further described with respect to FIGS. 3A, 3B, 6, and/or 7).

In some examples, a user may execute a transaction (e.g., a buy order or a sell order) using clients 102 to view cryptocurrency information such as pricing of a particular token expressed in a fiat currency. The user may submit an order (e.g., via clients 102 to orchestration 104) indicating an amount to buy/sell, which may be expressed in number of tokens of the cryptocurrency and/or amount in fiat currency. Orchestration 104 (corresponding to software and/or systems for coordinating transactions with a transaction platform such as transaction platform 110), may establish a time-guaranteed exchange rate (e.g., via transaction platform 110 that may include and/or interface with a pricing engine for providing real-time market prices/exchange rates) for the order. Orchestration 104 may also provide the user with additional transaction details, via clients 102, such as fees and further confirm whether the order presents any unacceptable risk and/or compliance issues (via a risk/compliance 108 corresponding to software and/or systems for assessing risk and/or compliance issues which in some examples may be implemented with a rule engine applying rules based on transaction parameters to automatically reject certain transactions). Once the user confirms the order (e.g., after accepting fees and/or confirmation of no potential risk/compliance issues), orchestration 104 may interface with payments 106 (corresponding to software/systems for managing or otherwise interfacing with a user's funding instrument such as a bank account and/or other assets) to debit or credit the user according to the order. Orchestration 104 may further execute the order/trade, at the quoted price, using transaction platform 110 to source/sell tokens with market makers and/or market exchanges (which in some examples may correspond to a public blockchain 120 that records market transactions and a custody 121 that may secure private keys of corresponding digital wallets) via transaction system 112. For example, transaction platform 110 may update a ledger 111 (corresponding to one or more record-keeping systems of transactions for cryptocurrencies and/or other digital currencies, may be implemented with a blockchain-based ledger, and may be public or private). In some examples, transaction platform 110 may directly transfer tokens to/from the user's digital wallet for the cryptocurrency. In other examples, transaction platform 110 may transfer tokens to an internal digital wallet, and separately track (e.g., via an internal iteration of ledger 111) the user's balances.

However, transaction platform 110 may rely on a separate transaction system (e.g., transaction system 112) for pricing information and executing orders with a market exchange. This separate transaction system may be subject to outages, such as issues with network connectivity, system errors or other unplanned system downtime, as well as planned downtime (e.g., for maintenance, upgrades, etc.). Transaction platform 110 may not be able to directly address such outages of transaction system 112 such that transaction platform 110 may be unable to complete orders.

FIG. 1 further illustrates a backup asset pool 126 (e.g., a separate cryptocurrency digital wallet that may be untethered from transaction system 112) that may be associated with a cryptocurrency transaction system (not shown in FIG. 1) that may be independent from the primary transaction system and/or otherwise not subject to the same outages concurrently with the primary transaction system (e.g., transaction system 112). As described herein, transaction platform 110 may detect outages of transaction system 112 (e.g., via detecting a lack of network connection to the primary transaction system, a lack of responses from the primary transaction system, receiving erroneous communications from the primary transaction system, receiving a notification of an outage from the primary transaction system, etc.) and in response, connect to and interface with a backup transaction platform in order to complete orders with backup asset pool 126.

For example, when orchestration 104 interfaces with transaction platform 110, transaction platform 110 may, in response to detecting the outage with transaction system 112, determine that the primary asset pool is also unavailable and accordingly complete transactions with backup asset pool 126 and a stand-in ledger 118 (e.g., a ledger corresponding to backup asset pool 126 and/or custody 121) instead, for a backup or stand-in period. Transaction platform 110 may verify that backup asset pool 126 has sufficient assets for completing the order, and after the user confirms the order, debits/credits payments 106, completes the order with backup asset pool 126 (e.g., transferring assets to/from backup asset pool 126, recording the transaction in stand-in ledger 118), and may further record the update to the user's assets in ledger 111.

In some examples, after the outage of the primary transaction system is over (e.g., transaction platform 110 detects that transaction system 112 is available again and the stand-in period ends), transaction platform 110 may settle the transactions performed with backup asset pool 126 (e.g., as recorded in stand-in ledger 118) with transaction system 112, to transfer assets to/from backup asset pool 126 to the digital wallet associated with the primary transaction system (which may be recorded with public blockchain 120 and custody 121). Further, in some examples, transaction platform 110 may also replenish or drain backup asset pool 126 as needed, as will be explained further below.

FIG. 2 is a flow diagram of an exemplary computer-implemented method 200 for a backup exchange transaction system. The steps shown in FIG. 2 may be performed by any suitable computer-executable code and/or computing system, including the system(s) illustrated in FIGS. 1, 3A-3B, 4, 6 and/or 7. In one example, each of the steps shown in FIG. 2 represent an algorithm whose structure includes and/or is represented by multiple sub-steps, examples of which will be provided in greater detail below.

As illustrated in FIG. 2, at step 202 one or more of the systems described herein may detect an unavailability of a primary cryptocurrency exchange system, wherein the primary cryptocurrency exchange system corresponds to a primary asset pool. For example, transaction platform 110 may detect the unavailability of transaction system 112.

The systems described herein may perform step 202 in a variety of ways. In one example, transaction platform 110 may detect that transaction system 112 is unresponsive for a threshold amount of time (e.g., corresponding to service and/or other technical issues with transaction system 112 itself and/or a network connection therebetween), and/or reaching a scheduled time of outage that transaction system 112 previously announced.

At step 204 one or more of the systems described herein may queue received cryptocurrency transaction requests. For example, transaction platform 110 and/or orchestration 104 may queue received cryptocurrency transaction requests from clients 102. In some examples, transaction platform 110 and/or orchestration 104 may queue transactions until detecting transaction system 112 is available again. More specifically, in some examples, transaction platform 110 and/or orchestration 104 may queue cryptocurrency transaction requests received and/or otherwise not completed in response to detecting the unavailability of the primary cryptocurrency exchange system (e.g., at step 202). Transaction platform 110 and/or orchestration 104 may in some implementations stop queueing cryptocurrency transaction requests when the primary cryptocurrency exchange system is available again for completing transactions, although in some examples the queueing may continue until the primary cryptocurrency exchange system completes all queued transaction requests.

At step 206 one or more of the systems described herein may connect, in response to the detection, to a backup cryptocurrency exchange system, wherein the backup cryptocurrency exchange system corresponds to a backup asset pool. For example, transaction platform 110 may connect to a separate transaction platform that corresponds to backup asset pool 126. More specifically, in some examples, transaction platform 110 may connect to transaction system 112 associated with backup asset pool 126 when detecting the primary cryptocurrency exchange system is unavailable.

At step 208 one or more of the systems described herein may complete the queued cryptocurrency transaction requests with the backup asset pool using the backup cryptocurrency exchange system. For example, transaction platform 110 may complete the queued cryptocurrency transaction requests with backup asset pool 126.

The systems described herein may perform step 208 in a variety of ways. In one example, the backup cryptocurrency exchange system may complete queued transactions using backup asset pool 126 and recording transactions in stand-in ledger 118.

In some examples, transaction platform 110 and/or the backup cryptocurrency exchange system may detect backup asset pool 126 falling below a value threshold, which may correspond to a minimum asset value for backup asset pool 126, below which further transactions may not be desired and/or available (e.g., for transferring out of backup asset pool 126). For instance, when backup asset pool 126 falls below the value threshold, backup asset pool 126 may lack assets for completing transactions, which in some examples may further correspond to a projected value if a transaction were completed. In response, transaction platform 110 may cancel transaction requests with backup asset pool 126 (e.g., keeping transaction queued) and complete the cancelled transaction requests with transaction system 112 (and the corresponding primary asset pool) after reconnecting to transaction system 112.

At step 210 one or more of the systems described herein may detect an availability of the primary cryptocurrency exchange system. For example, transaction platform 110 may detect the availability of transaction system 112.

The systems described herein may perform step 210 in a variety of ways. In one example, transaction platform 110 may periodically attempt to communicate with transaction system 112 for a proper response. In other examples, transaction platform 110 may attempt to communicate with transaction system 112 after a predetermined amount of time (e.g., corresponding to an end of the scheduled outage). In yet other examples, transaction system 112 may announce its availability to transaction platform 110.

At step 212 one or more of the systems described herein may reconnect to the primary cryptocurrency exchange system. For example, transaction platform 110 may reconnect to transaction system 112.

The systems described herein may perform step 212 in a variety of ways. In one example, in response to detecting the availability of transaction system 112, transaction platform 110 may reestablish its network connection to transaction system 112 to allow transactions with transaction system 112.

In some implementations, after performing transactions with backup asset pool 126, transaction platform 110 may perform settlement transactions (e.g., one more transactions for settling and/or accounting for an updated balance) for backup asset pool 126 to replenish and/or otherwise update backup asset pool 126 based on completed transactions. For example, transaction platform 110 may perform, in response to reconnecting to transaction system 112, a settlement transaction (recorded in public blockchain 120 and/or custody 121) between the primary asset pool and backup asset pool 126 based on the completed queued cryptocurrency transaction requests (e.g., as recorded in stand-in ledger 118). In some examples, transaction platform 110 may also disconnect, in response to reconnecting to transaction system 112, from the backup cryptocurrency exchange system.

In some examples, multiple backup systems and/or components thereof may be used, such as multiple iterations of backup asset pool 126 and related systems described herein. FIGS. 3A-3B illustrate an example backup cryptocurrency exchange system.

FIG. 3A illustrates a system 300 (e.g., corresponding to system 100 and/or aspects thereof) for a workflow of performing transactions for a cryptocurrency transaction backup system. FIG. 3B illustrates a system 301 (e.g., corresponding to system 100 and/or aspects thereof) for a workflow of settling assets for the cryptocurrency transaction backup system in connection with system 300. A user 303 may use a crypto client 302 (e.g., corresponding to clients 102) for viewing/managing cryptocurrency assets, that may correspond to a system (e.g., a computing device such as a server as described herein) with a user interface (e.g., software and/or related hardware) that interfaces with other systems/servers as needed to allow users to initiate cryptocurrency transactions. Crypto client 302 may interface with a pricing engine 322 (corresponding to a service for providing real-time market prices of relevant cryptocurrencies, which in some examples may poll/cache an active cryptocurrency partner such as primary transaction system 312, and may be implemented with a computing device such as a server as described herein) associated with a primary transaction system 312 (corresponding to transaction system 112) to provide user 303 with current prices.

When user 303 initiates a transaction (e.g., buying or selling) based on the current prices, an asset application programming interface (API) 304 (corresponding to orchestration 104) may coordinate with a transaction router 314 that manages connections to cryptocurrency transaction systems and corresponds to aspects of transaction platform 110. Asset API 304 may correspond to software interfaces allowing communication between computing devices/servers (e.g., crypto client 302 and transaction router 314) that in some examples is implemented with a computing device or server as described herein. Transaction router 314 may correspond to a computing device/server that may connect to various other systems as needed to facilitate transaction. If transaction router 314 detects that primary transaction system 312 and/or pricing engine 322 is unavailable, transaction router 314 may instead connect to a backup pricing engine 320 and a backup trade engine 318 as needed (e.g., connecting to backup pricing engine 320 when pricing engine 322 is unavailable, and/or connecting to backup trade engine 318 when primary transaction system 312 is unavailable) for completing transactions, as will be described further below. Backup pricing engine 320 may correspond to a server and/or service for providing pricing information (e.g., a pricing engine as described herein) that may further be independent from pricing engine 322. Backup trade engine 318 may correspond to a server and/or service for completing transactions independently from primary transaction system 312.

FIG. 3B illustrates aspects of settlement transactions (e.g., a settlement 360) that transaction router 314 may coordinate after reconnecting with a primary transaction platform 330 (corresponding to primary transaction system 312 and/or pricing engine 322) that is associated with a primary wallet 324 (e.g., a digital wallet for cryptocurrencies that is a primary or otherwise higher priority asset pool for conducting transactions). A transaction queue 332 may include transactions that were queued while primary transaction platform 330 was unavailable. In some examples, transaction queue 332 may correspond to a queue or other similar data structure (e.g., first-in-first-out (FIFO) or other structure that may preserve transaction timestamps and/or order of transactions) which may be implemented with transaction router 314 (e.g., stored on a storage device accessible to transaction router 314), although in other examples, transaction queue 332 may be implemented with and/or have a copy available to backup trade engine 318. Transactions (which may have been queued in transaction queue 332) using a backup wallet 326 (e.g., a digital wallet for cryptocurrencies corresponding to backup asset pool 126 that is a backup or otherwise lower priority asset pool for conducting transactions, and is further untethered from primary transaction platform 330) may be recorded in trade queue table 334 (e.g., corresponding to stand-in ledger 118). Settlement 360, which may be implemented with a computing device/server (e.g., one or more of primary transaction system 312, backup trade engine 318, primary transaction platform 330) and/or implemented as a automatic or semi-autonomous process from transaction router 314, may update backup wallet 326 and/or primary wallet 324 to replenish/rebalance assets, transfer assets as needed, etc., as will be described further below.

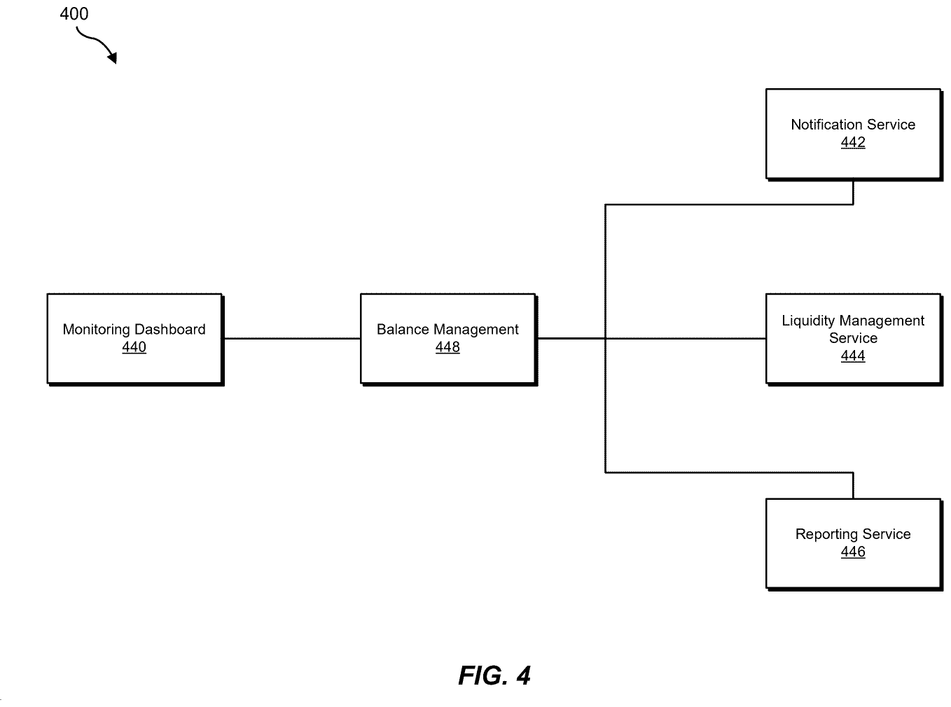

FIG. 4 illustrates a system 400 for managing a backup asset pool (e.g., backup asset pool 126 and/or backup wallet 326). A monitoring dashboard 440 (corresponding to an interface, API, and/or service implemented with a computing device/server such as crypto client 302 and/or transaction router 314) can provide interface with various systems/services, such as a balance management 448, a notification service 442, a liquidity management service 444, and a reporting service 446. Balance management 448 (corresponding to an API and/or service implemented with a computing device/server such as crypto client 302 and/or transaction router 314 and communicating with monitoring dashboard 440) may provide information about the backup asset pool, such as current value (e.g., connecting to an appropriate ledger and/or wallet such as backup wallet 326) and completed transactions, which can further reflect current market price (e.g., by connecting to an appropriate pricing engine such as pricing engine 322). In some implementations, system 400 may manage more than one asset pool.

Liquidity management service 444 (corresponding to an API and/or service implemented with a computing device/server such as crypto client 302 and/or transaction router 314 and communicating with monitoring dashboard 440) may provide information relating to various thresholds, such as value thresholds or limits, and/or other analysis relating to recommended liquidity of the backup asset pool. The recommended liquidity may be based on an appropriate reserve capacity for the backup asset pool, such as analysis on historical outages of the primary transaction system, value of transactions during the historical outages, regulatory/compliance and/or risk considerations, etc., which in some implementations may be determined through heuristics, statistical analysis, machine learning, etc.

In some implementations, liquidity management service 444 and/or balance management 448 may automatically perform settlement transactions, such as adding assets (e.g., from a primary asset pool and/or other asset pool) when the backup asset pool falls below the value threshold/limit (indicating a risk of depletion), replicating some or all transactions performed with the backup asset pool (e.g., restoring the value to before the transactions during a stand-in period), distributing assets to other asset pools as needed (e.g., if the value exceeds an upper threshold and/or another asset pool requires replenishing), etc. For example, as shown in FIG. 3B, settlement 360 may include transferring assets between backup wallet 326 and primary wallet 324. Liquidity management service 444 may further track asset movement transaction completion and failure tracking, as well as allow configuration of replenishment parameters (e.g., transaction request dates, transaction types, assets/cryptocurrencies, quantity, fiat values, execution type such as spot or limit, deposit location post purchase, etc.)

In some implementations, monitoring dashboard 440 may allow a user/administrator to perform and/or approve settlement transactions and/or other transactions and further track such approvals. Notification service 442 (corresponding to an API and/or service implemented with a computing device/server such as crypto client 302 and/or transaction router 314 and communicating with monitoring dashboard 440) may provide notifications as needed, such as if the value falls below the value threshold/limit and/or exceeds the upper threshold, provide recommended actions (e.g., a settlement transaction as recommended by liquidity management service 444), and/or request verification of transactions (e.g., settlement transactions and/or user-requested transactions during a stand-in period). In addition, notification service 442 and/or reporting service 446 may provide reports of completed transactions.

Reporting service 446 (corresponding to an API and/or service implemented with a computing device/server such as crypto client 302 and/or transaction router 314 and communicating with monitoring dashboard 440) may further provide reports of metrics, analysis, etc., for the administrator to adjust parameters (e.g., thresholds, timing of transactions, etc.) as desired via monitoring dashboard 440. For example, reporting service 446 may facilitation report generation and storage as well as allow export/download of custom reports. In some implementations, reporting service 446 may allow querying ability of reports, error reporting, and/or analytics (e.g., trends).

In some examples, monitoring dashboard 440 may allow configuration of notification types and/or medium for notifications, triggers and/or frequencies of notifications, recipients of notifications, etc. In some implementations, notifications may include health checks (e.g., availability of transaction systems and/or notifications of other issues), stand-in system activation (e.g., when a backup transaction system is connected to and/or used), balance alarms (e.g., passing lower and/or upper thresholds such as the value thresholds described herein), threshold limit alarms, asset replenishment alarms, and/or error reporting.

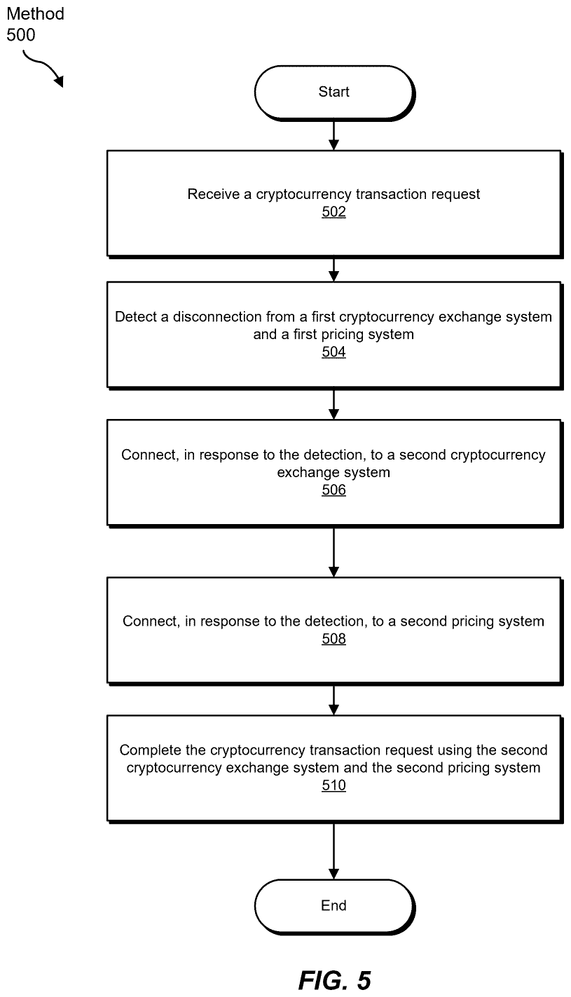

FIG. 5 is a flow diagram of an exemplary computer-implemented method 500 for a backup exchange transaction system. The steps shown in FIG. 5 may be performed by any suitable computer-executable code and/or computing system, including the system(s) illustrated in FIGS. 1, 3A-3B, 4, 6 and/or 7. In one example, each of the steps shown in FIG. 5 represent an algorithm whose structure includes and/or is represented by multiple sub-steps, examples of which will be provided in greater detail below.

As illustrated in FIG. 5, at step 502 one or more of the systems described herein may receive a cryptocurrency transaction request. For example, crypto client 302 may receive a cryptocurrency transaction request from user 303, which may be intended for a first asset pool (e.g., primary wallet 324).

At step 504 one or more of the systems described herein may detect a disconnection from a first cryptocurrency exchange system and a first pricing system. For example, transaction router 314 may detect a disconnection from primary transaction system 312, primary transaction platform 330, and/or pricing engine 322.

The systems described herein may perform step 504 in a variety of ways. In one example, transaction router 314 may detect a problem with a network connection itself (e.g., issues with wired and/or wireless communications, reduction of bandwidth below an acceptable performance level for performing real-time transactions, etc.) to primary transaction system 312 and/or pricing engine 322, for instance by detecting network failures. In other examples, transaction router 314 may detect a problem with primary transaction system 312 and/or pricing engine 322 themselves (e.g., detecting errors in communications, responsiveness below acceptable thresholds, announced outages, etc.). The first cryptocurrency exchange system (e.g., primary transaction system 312) may corresponds to the first asset pool (e.g., primary wallet 324) for completing cryptocurrency transactions such that when primary transaction system 312 and/or pricing engine 322 are unavailable, transaction router 314 may be unable to complete transactions with the first asset pool.

At step 506 one or more of the systems described herein may connect, in response to the detection, to a second cryptocurrency exchange system. For example, transaction router 314 may connect to backup trade engine 318 in response to detecting the disconnection from primary transaction system 312.

The systems described herein may perform step 506 in a variety of ways. In one example, transaction router 314 may confirm that backup trade engine 318 (corresponding to a second asset pool such as backup wallet 326 for completing cryptocurrency transactions) is available and accordingly establish a connection. In some examples, transaction router 314 may attempt to connect to multiple different iterations of backup trade engine 318 (which may be associated with separate secondary asset pools and/or share secondary asset pools) and establish the connection with the most responsive iteration. In some examples, transaction router 314 may maintain the connection with backup trade engine 318 (e.g., while primary transaction system 312 is available) such that connecting to backup trade engine 318 may not incur significant latency.

At step 508 one or more of the systems described herein may connect, in response to the detection, to a second pricing system. For example, transaction router 314 may connect to backup pricing engine 320.

The systems described herein may perform step 508 in a variety of ways. In one example, transaction router 314 may confirm that backup pricing engine 320 is available and accordingly establish a connection. In some examples, transaction router 314 may attempt to connect to multiple different iterations of backup pricing engine 320 and establish the connection with the most responsive iteration. In some examples, transaction router 314 may maintain the connection with backup trade engine 320 (e.g., while primary transaction system 312 and/or pricing engine 322 is available) such that connecting to backup trade engine 318 may not incur significant latency.

At step 510 one or more of the systems described herein may complete the cryptocurrency transaction request using the second cryptocurrency exchange system and the second pricing system. For example, transaction router 314 may complete the cryptocurrency transaction request using backup trade engine 318.

The systems described herein may perform step 510 in a variety of ways. In one example, completing the cryptocurrency transaction request using backup trade engine 318 and backup pricing engine 320 further comprises completing the cryptocurrency transaction request with the second asset pool based on a price from backup pricing engine 320. In some examples, during a stand-in period (e.g., when primary transaction system 312 and/or primary transaction platform 330 is unavailable), crypto client 302 may receive multiple transaction requests. Transaction router 314 may queue these transaction requests in transaction queue 332 for completion by backup trade engine 318.

In some examples, transaction router 314 and/or liquidity management service 444 may monitor backup wallet 326 for crossing a value limit (e.g., indicating that a transaction may cause backup wallet 326 to cross the value limit and that a settlement transaction may be needed). In response to the monitoring (e.g., that a transaction will cause backup wallet 326 to cross the value limit), transaction router 314 and/or notification service 442 may provide a notification (e.g., to monitoring dashboard 440 and/or other communication services). Further, transaction router 314 and/or balance management 448 may pause cryptocurrency transaction requests (e.g., halting transactions from transaction queue 332) to prevent backup wallet 326 from crossing the value limit.

In some examples, transaction router 314 may detect an available connection with the first cryptocurrency exchange system (e.g., indicating that primary transaction system 312 and/or primary transaction platform 330 is available again, ending the stand-in period). Transaction router 314 may reconnect to the first cryptocurrency exchange system, and perform a settlement transaction, between primary wallet 324 and backup wallet 326 based on the completed cryptocurrency transaction request (e.g., as recorded in trade queue table 334) as described herein. Moreover, in some implementations, transaction router 314 may further disconnect from the second cryptocurrency exchange system (e.g., backup trade engine 318).

FIG. 6 is a block diagram of an example system 600 (corresponding to transaction platform 110 and/or other aspects of system 100, and transaction router 314 and/or other aspects of system 300) for a cryptocurrency transaction backup system. As illustrated in this figure, example system 600 includes one or more modules 602 for performing one or more tasks. As will be explained in greater detail herein, modules 602 include a detection module 604, a connection module 606, a transaction module 608, and a monitor module 610. Although illustrated as separate elements, one or more of modules 602 in FIG. 6 may represent portions of a single module or application.

In certain implementations, one or more of modules 602 in FIG. 6 may represent one or more software applications or programs that, when executed by a computing device, causes the computing device to perform one or more tasks. For example, and as will be described in greater detail below, one or more of modules 602 may represent modules stored and configured to run on one or more computing devices, such as the devices illustrated in FIG. 7 (e.g., computing device 702 and/or server 706A-B). In some implementations, a module may be implemented as a circuit. One or more of modules 602 in FIG. 6 may also represent all or portions of one or more special-purpose computers configured to perform one or more tasks.

As illustrated in FIG. 6, example system 600 also includes one or more memory devices, such as memory 640. Memory 640 generally represents any type or form of volatile or non-volatile storage device or medium capable of storing data and/or computer-readable instructions. In one example, memory 640 stores, loads, and/or maintains one or more of modules 602. Examples of memory 640 include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

As illustrated in FIG. 6, example system 600 also includes one or more physical processors, such as physical processor 630. Physical processor 630 generally represents any type or form of hardware-implemented processing unit capable of interpreting and/or executing computer-readable instructions. In one example, physical processor 630 accesses and/or modifies one or more of modules 602 stored in memory 640. Additionally, or alternatively, physical processor 630 executes one or more of modules 602 to train and use a multi-label shallow neural network for tabular data. Examples of physical processor 630 include, without limitation, microprocessors, microcontrollers, Central Processing Units (CPUs), graphical processing units (GPUs), Field-Programmable Gate Arrays (FPGAs) that implement softcore processors, Application-Specific Integrated Circuits (ASICs), systems on a chip (SoCs), portions of one or more of the same, variations or combinations of one or more of the same, and/or any other suitable physical processor.

As illustrated in FIG. 6, example system 600 also includes one or more additional elements 620, such as a transaction request 622, primary asset pool data 624, backup asset pool data 626, and pricing data 628, some or all of which may be stored on a local storage device, such as memory 640, or may be accessed remotely. Transaction request 622 may correspond to a transaction request for a digital asset (e.g., cryptocurrency). Primary asset pool data 624 may correspond to data relating to a primary or first asset pool (e.g., primary wallet 324 and/or other relevant data for performing transactions). Backup asset pool data 626 may correspond to a backup or second asset pool (e.g., backup wallet 326 and/or other relevant data for performing transactions). Pricing data 628 may correspond to pricing data (e.g., as retrieved from pricing engine 322 and/or backup pricing engine 320).

Example system 600 in FIG. 6 may be implemented in a variety of ways. For example, all or a portion of example system 600 represent portions of example network environment 700 in FIG. 7.

FIG. 7 illustrates an exemplary network environment 700 implementing aspects of the present disclosure. The network environment 700 includes computing device 702, a network 704, a server 706A, and a server 706B. Computing device 702 may be a server for a transaction platform (e.g., corresponding to transaction platform 110 and/or transaction router 314 and in some implementations system 600), and in some implementations may further correspond to and/or represent a client device or user device, such as a desktop computer, laptop computer, tablet device, smartphone, or other computing device corresponding to clients 102 and/or crypto client 302. Computing device 702 includes a physical processor 630, which may be one or more processors, memory 640, which may store data such as one or more of additional elements 620 (e.g., transaction request 622). In some implementations, computing device 702 represents a device connected to an exchange transaction system that may be used for viewing/managing digital assets and/or performing transactions.

Server 706A and server 706B each represent or include one or more servers and/or other computing devices capable of performing transactions of digital assets, such as cryptocurrencies. In some examples, server 706A may also correspond to a primary or first exchange transaction system (e.g., transaction system 112, primary transaction system 312, pricing engine 322, and/or primary transaction platform 330) and server 706B may correspond to a backup or second exchange transaction system (e.g., stand-in ledger 118, backup trade engine 318, and/or backup pricing engine 320). Server 706A and server 706B each include a physical processor 630, which may include one or more processors, memory 640, which may store modules 602, and one or more of additional elements 620 (e.g., server 706A storing primary asset pool data 624 and pricing data 628, and server 706B storing backup asset pool data 626 and pricing data 628).

Computing device 702 is communicatively coupled to server 706A and server 706B through network 704. Network 704 represents any type or form of communication network, such as the Internet, and may comprise one or more physical connections, such as LAN, and/or wireless connections, such as WAN. As further illustrated in FIG. 7, computing device 702 may be communicatively coupled to server 706A through a network connection 705A, and communicatively coupled to server 706B through a network connection 705B. As described above, network connection 705A (and/or network connection 705B in some examples) may become disconnected or otherwise unavailable, such as due to issues with network 704 and/or portions thereof, and/or due to issues with server 706A (and/or server 706B). As will be described further below, computing device 702 may facilitate transactions with server 706B (via network connection 705B) when server 706A and/or network connection 705A are unavailable.

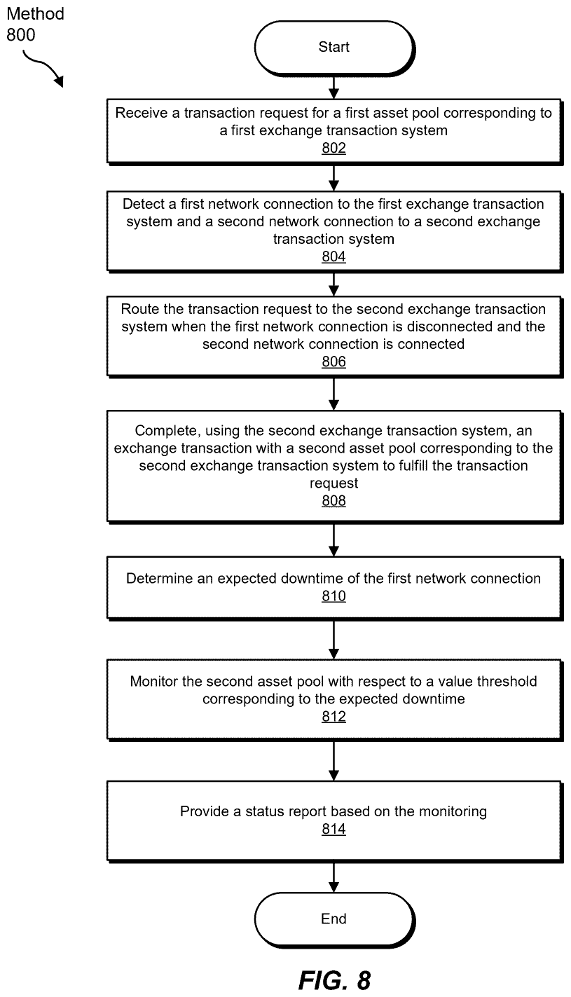

FIG. 8 is a flow diagram of an exemplary computer-implemented method 800 for a backup exchange transaction system. The steps shown in FIG. 8 may be performed by any suitable computer-executable code and/or computing system, including the system(s) illustrated in FIGS. 1, 3A-3B, 4, 6 and/or 7. In one example, each of the steps shown in FIG. 8 represent an algorithm whose structure includes and/or is represented by multiple sub-steps, examples of which will be provided in greater detail below.

As illustrated in FIG. 8, at step 802 one or more of the systems described herein may receive a transaction request for a first asset pool corresponding to a first exchange transaction system. For example, system 600 (e.g., transaction module 608 and/or computing device 702) may receive transaction request 622.

At step 804 one or more of the systems described herein may detect a first network connection to the first exchange transaction system and a second network connection to a second exchange transaction system. For example, detection module 604 may detect a first network connection (e.g., network connection 705A) to the first exchange transaction system (e.g., server 706A) and a second network connection (e.g., network connection 705B) to the second exchange transaction system (e.g., server 706B).

The systems described herein may perform step 804 in a variety of ways. In one example, detecting the first network connection (e.g., network connection 705A) may be based on periodically connecting to the first exchange transaction system. In other examples, detection module 604 may detect whether network connection 705A is available in response to receiving transaction request 622 which may reference primary asset pool data 624, such that detection module 604 may test a network connection to a transaction system corresponding to an asset pool from transaction request 622. In some examples, transaction request 622 may expressly refer to primary asset pool data 624, although in other examples, transaction request 622 may default to primary asset pool data 624.

At step 806 one or more of the systems described herein may route the transaction request to the second exchange transaction system when the first network connection is disconnected and the second network connection is connected. For example, transaction module 608 and/or connection module 606 may route transaction request 622 to the second exchange transaction system (e.g., server 706B) when network connection 705A is disconnected and network connection 705B is available.

The systems described herein may perform step 806 in a variety of ways. In one example, network connection 705A itself may be unavailable (e.g., due to issues with network 704, etc. as described herein). In other examples, network connection 705A may be available and server 706A may be unavailable (e.g., not able to perform transactions as described herein) such that detection module 604 and/or connection module 606 may consider network connection 705A disconnected and/or unavailable.

In some examples, connection module 606 may also connect, in response to network connection 705A being disconnected, to a pricing system (e.g., backup pricing engine 320), which in some examples may be connected via server 706B.

At step 808 one or more of the systems described herein may complete, using the second exchange transaction system, an exchange transaction (e.g., transaction request 622) with a second asset pool corresponding to the second exchange transaction system to fulfill the transaction request. For example, the second exchange transaction system (e.g., server 706B) may complete transaction request 622 using the second asset pool (e.g., corresponding to backup asset pool data 626).

The systems described herein may perform step 808 in a variety of ways. In one example, server 706B may complete transaction request 622 using pricing data 628 from the pricing system associated with backup asset pool data 626 and accordingly updating backup asset pool data 626.

In some examples, transaction request 622 may be queued (e.g., in transaction queue 332 as described herein) and server 706B may process the queued transaction request (e.g., in time order of oldest to most recent). In some examples, monitor module 610 may determine from backup asset pool data 626 that the second asset pool may be insufficient for completing transaction request 622, and transaction module 608 may accordingly pause transaction request 622 (e.g., pausing the transaction queue). Further, in some examples, monitor module 610 may monitor a volume of transactions (e.g., a size of the transaction queue) routed to the second exchange transaction system (e.g., server 706B) and pause the exchange transaction in response to the volume of transactions exceeding a volume threshold. In some examples, the volume threshold may correspond to a value threshold or other limit as described herein. In some examples, the volume threshold may correspond to regulatory/compliance and/or risk-related factors. Moreover, in some examples, the volume threshold may correspond to a workload and/or bandwidth of server 706B. In addition, in some implementations, in response to pausing the transaction queue, system 600 (e.g., transaction module 608 and/or connection module 606) may further connect to additional transaction systems (e.g., different independent iterations of server 706A and/or server 706B) and route transactions thereto, to continue processing the transaction queue with a different available transaction system.

Continuing to step 810, at step 810 one or more of the systems described herein may determine an expected downtime of the first network connection. For example, connection module 606 and/or monitor module 610 may determine an expected downtime of network connection 705A (e.g., corresponding to an expected outage of server 706A).

The systems described herein may perform step 810 in a variety of ways. In one example, connection module 606 may determine the expected downtime based on analysis as described herein, including analysis of historical performance of server 706A, network connection 705A, and/or network 704. For instance, connection module 606 may determine an average time, weighted average time, a predicted time based on factors (including but not limited to time of day/month/year, performance metrics, etc.), and/or a time corresponding to historical announced outages.

At step 812 one or more of the systems described herein may monitor the second asset pool with respect to a value threshold corresponding to the expected downtime. For example, monitor module 610 may monitor the second asset pool (e.g., corresponding to backup asset pool data 626) with respect to the value threshold corresponding to the expected downtime.

The systems described herein may perform step 812 in a variety of ways. In one example, monitor module 610 may establish the value threshold based on, in some implementations, a predicted volume of transactions/value of assets to be processed by server 706A for the expected downtime. For instance, monitor module 610 may determine the value threshold to anticipate a total value of transactions during the expected downtime. In some examples, monitoring module 610 (e.g., notification service 442) may provide a notification in response to detecting the second asset pool crossing the value threshold.

In some examples, monitor module 610 may transfer assets from the first asset pool to the second asset pool in response to the second asset pool crossing the value threshold and the first network connection is connected, performing a settlement transaction as described herein. For instance, connection module 606 may detecting that network connection 705A is reconnected, and accordingly transaction module 608 may route exchange transactions to server 706A. Moreover, in some examples monitor module 610 may perform, in response to detecting network connection 705A is reconnected, a balancing between the first asset pool and the second asset pool (e.g., updating primary asset pool data 624 and/or backup asset pool data 626 as needed).

At step 814 one or more of the systems described herein may provide a status report based on the monitoring. For example, monitor module 610 may provide a status report.

The systems described herein may perform step 814 in a variety of ways. In one example, monitoring module 610 (e.g., reporting service 446) may provide the status report of completed transactions, paused transactions, and which transaction systems (e.g., server 706A and/or server 706B) processed transactions.

The systems and methods described herein may provide stand-in capability to allow consumers to initiate the cryptocurrency trade buy/sell operations and hold even during an unavailability of a primary transaction system. The stand-in capability may advantageously provide partner health checks and notifications and provides connectivity to third-party pricing oracles for retrieving fair market prices of cryptocurrencies. The systems and methods described herein further provide rule engine-based transaction routings, and managing/validating the stand-in balance (e.g., backup asset pool). Further, the systems and methods described herein allow delayed net settlement with the primary transaction system, such as settling/transferring the assets between the primary asset pool and the backup asset pool.

The systems and methods described herein also allow management of a liquidity pool (e.g., backup asset pool), providing a user interface to the stand-in liquidity pool. The balance management system may provide finance personnel to query cryptocurrency balances and buy/sell cryptocurrency assets to fill/drain the liquidity pool. The balance management system may also provide metrics and dashboards that finance personnel may use to determine and/or adjust the appropriate reserve capacity for the liquidity pool, as well as provide alerts when the liquidity pool is in danger of depletion.

Accordingly, the systems and methods described herein may detect network connection and/or other hardware issues (and/or effects thereof) of a primary transaction system, and in response connect to an available backup transaction system transparently to users. Such a system may mitigate an overall reduction in performance relating to the downtime of the primary transaction system.

Although the examples described herein generally refer to cryptocurrencies, in other examples, the transaction systems may correspond to other digital currencies, ledger-based transactions, and/or blockchain-based systems.

In one implementation, a system for cryptocurrency transaction backup includes a processor, and a non-transitory computer-readable medium having stored thereon instructions that are executable by the processor to cause the system to perform operations including: (i) detecting an unavailability of a primary cryptocurrency exchange system, wherein the primary cryptocurrency exchange system corresponds to a primary asset pool, (ii) queuing received cryptocurrency transaction requests, (iii) connecting, in response to the detection, to a backup cryptocurrency exchange system, wherein the backup cryptocurrency exchange system corresponds to a backup asset pool, (iv) completing the queued cryptocurrency transaction requests with the backup asset pool using the backup cryptocurrency exchange system, (v) detecting an availability of the primary cryptocurrency exchange system, and (vi) reconnecting to the primary cryptocurrency exchange system.

In some examples, wherein the instructions further cause the system to perform operations including: (a) detecting the backup asset pool falling below a value threshold, (b) cancelling transaction requests with the backup asset pool, and (c) completing the cancelled transaction requests with the primary asset pool after reconnecting to the primary cryptocurrency exchange system.

In some examples, the instructions further cause the system to perform operations comprising performing, in response to reconnecting to the primary cryptocurrency exchange system, a settlement transaction between the primary asset pool and the backup asset pool based on the completed queued cryptocurrency transaction requests. In some examples, the instructions further cause the system to perform operations comprising disconnecting, in response to reconnecting to the primary cryptocurrency exchange system, from the backup cryptocurrency exchange system.

In some examples, the above-described method may be encoded as computer-readable instructions on a non-transitory computer-readable medium. For example, a computer-readable medium includes one or more computer-executable instructions that, when executed by at least one processor of a computing device, causes the computing device to perform operations including: (i) receiving a cryptocurrency transaction request, (ii) detecting a disconnection from a first cryptocurrency exchange system and a first pricing system, (iii) connecting, in response to the detection, to a second cryptocurrency exchange system, (iv) connecting, in response to the detection, to a second pricing system, and (v) completing the cryptocurrency transaction request using the second cryptocurrency exchange system and the second pricing system.

In some examples, the first cryptocurrency exchange system corresponds to a first asset pool for completing cryptocurrency transactions and the second cryptocurrency exchange system corresponds to a second asset pool for completing cryptocurrency transactions. In some examples, completing the cryptocurrency transaction request using the second cryptocurrency exchange system and the second pricing system further comprises completing the cryptocurrency transaction request with the second asset pool based on a price from the second pricing system.

In some examples, the non-transitory computer-readable medium further includes instructions for: (a) monitoring the second asset pool for crossing a value limit, and (b) providing a notification in response to the second asset pool crossing the value limit. In some examples, the non-transitory computer-readable medium of claim 8, further includes instructions for pausing the cryptocurrency transaction request to prevent the second asset pool from crossing the value limit.

In some examples, the non-transitory computer-readable medium further includes instructions for: (c) detecting an available connection with the first cryptocurrency exchange system, (d) reconnecting to the first cryptocurrency exchange system, (e) performing a settlement transaction between the first asset pool and the second asset pool based on the completed cryptocurrency transaction request, and (f) disconnecting from the second cryptocurrency exchange system.

In one implementation, a computer-implemented method for a transactions with a backup transaction system includes: (i) receiving a transaction request for a first asset pool corresponding to a first exchange transaction system, (ii) detecting a first network connection to the first exchange transaction system and a second network connection to a second exchange transaction system, (iii) routing the transaction request to the second exchange transaction system when the first network connection is disconnected and the second network connection is connected, (iv) completing, using the second exchange transaction system, an exchange transaction with a second asset pool corresponding to the second exchange transaction system to fulfill the transaction request, (v) determining an expected downtime of the first network connection, (vi) monitoring the second asset pool with respect to a value threshold corresponding to the expected downtime, and (vii) providing a status report based on the monitoring.

In some examples, detecting the first network connection is based on periodically connecting to the first exchange transaction system. In some examples, the method further includes connecting, in response to the first network connection being disconnected, to a pricing system, wherein completing the exchange transaction includes using a price from the pricing system associated with the second asset pool.

In some examples, providing the status report further comprises providing a notification in response to detecting the second asset pool crossing the value threshold. In some examples, the method further includes transferring assets from the first asset pool to the second asset pool in response to the second asset pool crossing the value threshold and the first network connection is connected.

In some examples, the value threshold is based on an expected total value of transactions during the expected downtime. In some examples, the method further includes pausing the exchange transaction when the second asset pool is insufficient for the exchange transaction.

In some examples, the method further includes monitoring a volume of transactions routed to the second exchange transaction system and pausing the exchange transaction in response to the volume of transactions exceeding a volume threshold.

In some examples, the method further includes: (a) detecting the first network connection is reconnected, and (b) routing exchange transactions to the first exchange transaction system. In some examples, the method further includes performing, in response to detecting the first network connection is reconnected, a balancing between the first asset pool and the second asset pool.

Features from any of the implementations described herein may be used in combination with one another in accordance with the general principles described herein. These and other implementations, features, and advantages will be more fully understood upon reading the following detailed description in conjunction with the accompanying drawings and claims.

As detailed above, the computing devices and systems described and/or illustrated herein broadly represent any type or form of computing device or system capable of executing computer-readable instructions, such as those contained within the modules described herein. In their most basic configuration, these computing device(s) each include at least one memory device and at least one physical processor.

In some examples, the term “memory device” generally refers to any type or form of volatile or non-volatile storage device or medium capable of storing data and/or computer-readable instructions. In one example, a memory device stores, loads, and/or maintains one or more of the modules and/or circuits described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), systems on a chip (SoCs), digital signal processors (DSPs), Neural Network Engines (NNEs), accelerators, graphics processing units (GPUs), portions of one or more of the same, variations or combinations of one or more of the same, or any other suitable physical processor.

Although illustrated as separate elements, the modules described and/or illustrated herein may represent portions of a single module or application. In addition, in certain implementations one or more of these modules may represent one or more software applications or programs that, when executed by a computing device, cause the computing device to perform one or more tasks. For example, one or more of the modules described and/or illustrated herein represent modules stored and configured to run on one or more of the computing devices or systems described and/or illustrated herein. In some implementations, a module may be implemented as a circuit or circuitry. One or more of these modules may also represent all or portions of one or more special-purpose computers configured to perform one or more tasks.

In addition, one or more of the modules described herein transforms data, physical devices, and/or representations of physical devices from one form to another. For example, one or more of the modules recited herein receives tabular data to be transformed, transforms the data, outputs a result of the transformation to predict multiple labels, uses the result of the transformation to determine strategies, and stores the result of the transformation to apply the multiple labels. Additionally, or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and may be varied as desired. For example, while the steps illustrated and/or described herein are shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
a processor; and
a non-transitory computer-readable medium having stored thereon instructions that are executable by the processor to cause the system to perform operations comprising:
detecting an unavailability of a primary cryptocurrency exchange system, wherein the primary cryptocurrency exchange system corresponds to a primary asset pool;
queuing received cryptocurrency transaction requests;
connecting, in response to the detection, to a backup cryptocurrency exchange system, wherein the backup cryptocurrency exchange system corresponds to a backup asset pool;
completing the queued cryptocurrency transaction requests with the backup asset pool using the backup cryptocurrency exchange system;
detecting an availability of the primary cryptocurrency exchange system; and
reconnecting to the primary cryptocurrency exchange system.

2. The system of claim 1, wherein the instructions further cause the system to perform operations comprising:
detecting the backup asset pool falling below a value threshold;
cancelling transaction requests with the backup asset pool; and
completing the cancelled transaction requests with the primary asset pool after reconnecting to the primary cryptocurrency exchange system.

3. The system of claim 1, wherein the instructions further cause the system to perform operations comprising performing, in response to reconnecting to the primary cryptocurrency exchange system, a settlement transaction between the primary asset pool and the backup asset pool based on the completed queued cryptocurrency transaction requests.

4. The system of claim 1, wherein the instructions further cause the system to perform operations comprising disconnecting, in response to reconnecting to the primary cryptocurrency exchange system, from the backup cryptocurrency exchange system.

5. A non-transitory computer-readable medium having stored thereon instructions that are executable by a processor of a computing system to cause the computing system to perform operations comprising:
receiving a cryptocurrency transaction request;
detecting a disconnection from a first cryptocurrency exchange system and a first pricing system;
connecting, in response to the detection, to a second cryptocurrency exchange system;
connecting, in response to the detection, to a second pricing system; and
completing the cryptocurrency transaction request using the second cryptocurrency exchange system and the second pricing system.

6. The non-transitory computer-readable medium of claim 5, wherein the first cryptocurrency exchange system corresponds to a first asset pool for completing cryptocurrency transactions and the second cryptocurrency exchange system corresponds to a second asset pool for completing cryptocurrency transactions.

7. The non-transitory computer-readable medium of claim 6, wherein completing the cryptocurrency transaction request using the second cryptocurrency exchange system and the second pricing system further comprises completing the cryptocurrency transaction request with the second asset pool based on a price from the second pricing system.

8. The non-transitory computer-readable medium of claim 6, further comprising instructions for:
monitoring the second asset pool for crossing a value limit; and
providing a notification in response to the second asset pool crossing the value limit.

9. The non-transitory computer-readable medium of claim 8, further comprising instructions for pausing the cryptocurrency transaction request to prevent the second asset pool from crossing the value limit.

10. The non-transitory computer-readable medium of claim 6, further comprising instructions for:
detecting an available connection with the first cryptocurrency exchange system;
reconnecting to the first cryptocurrency exchange system;
performing a settlement transaction between the first asset pool and the second asset pool based on the completed cryptocurrency transaction request; and
disconnecting from the second cryptocurrency exchange system.

11. A computer-implemented method comprising:
receiving a transaction request for a first asset pool corresponding to a first exchange transaction system;
detecting a first network connection to the first exchange transaction system and a second network connection to a second exchange transaction system;
routing the transaction request to the second exchange transaction system when the first network connection is disconnected and the second network connection is connected;
completing, using the second exchange transaction system, an exchange transaction with a second asset pool corresponding to the second exchange transaction system to fulfill the transaction request;
determining an expected downtime of the first network connection;
monitoring the second asset pool with respect to a value threshold corresponding to the expected downtime; and
providing a status report based on the monitoring.

12. The method of claim 11, wherein detecting the first network connection is based on periodically connecting to the first exchange transaction system.

13. The method of claim 11, further comprising connecting, in response to the first network connection being disconnected, to a pricing system, wherein completing the exchange transaction includes using a price from the pricing system associated with the second asset pool.

14. The method of claim 11, wherein providing the status report further comprises providing a notification in response to detecting the second asset pool crossing the value threshold.

15. The method of claim 11, further comprising transferring assets from the first asset pool to the second asset pool in response to the second asset pool crossing the value threshold and the first network connection is connected.

16. The method of claim 11, wherein the value threshold is based on an expected total value of transactions during the expected downtime.

17. The method of claim 11, further comprising pausing the exchange transaction when the second asset pool is insufficient for the exchange transaction.

18. The method of claim 11, further comprising monitoring a volume of transactions routed to the second exchange transaction system and pausing the exchange transaction in response to the volume of transactions exceeding a volume threshold.

19. The method of claim 11, further comprising:
detecting the first network connection is reconnected; and
routing exchange transactions to the first exchange transaction system.

20. The method of claim 19, further comprising performing, in response to detecting the first network connection is reconnected, a balancing between the first asset pool and the second asset pool.
